(19) United States
(12) Patent Application Publication
(10) Pub. No.: US 2002/0122691 A1
(43) Pub. Date: Sep. 5, 2002

(54) Hardware mounting connector for profile extrusions

(76) Inventor: John Wood, Battle Creek, MI (US)

Correspondence Address: O'Malley and Firestone, 919 South Harrison Street, Suite 210, Fort Wayne, IN, 46802, US

(21) Appl. No.: 09/797,489

(22) Filed: Mar. 1, 2001

(51) Int. Cl. B25G 3/08

(52) U.S. Cl. 403/381

(57) ABSTRACT

A connector, freely insertable and removable to and from T-slots of aluminum profile extrusions after assembly of a frame constructed from a two profile extrusions is provided. The connector is orientable for retention in the slot, but no other retaining fasteners are required between a connector and a profile extrusion. The connectors provide points of support for objects to be mounted on a framework constructed from a plurality of extrusions. The supported objects in turn brace the accessories in the T-slots by locking the rotational orientation of the connector with respect to the profile extrusion.

### BACKGROUND OF THE INVENTION

1. Field of the Invention

The present invention relates to aluminum profile extrusions and more particularly to an accessory positionable in T-slots of such profile extrusions to provide points of support for objects to be mounted on a frame constructed from a plurality of profile extrusions. The supported objects in turn brace the accessories in the T-slots.

2. Description of the Prior Art

Structures built from modular framing systems based on aluminum alloy structural framing members (commonly termed “profiles” or “profile extrusions”) are lighter and more easily assembled than similar structures made from steel tubes. Ease of assembly and the absence of any need for welding, with consequential labor savings, is an important market place advantage of aluminum profiles over steel tubes. A feature of profile extrusions that confers these advantages is T-slot channels which run lengthwise along the profile extrusions and are open to the exterior faces of the extrusions. Aluminum profile extrusions can be fabricated with a T-slot because aluminum has a lower melting temperature than steel has allowing aluminum to be readily extruded at workable temperatures.

T-slots allow the quick and easy introduction of a wide variety of attachment accessories which may be oriented to cooperate with the interior surfaces of the T-slot for positioning and locking, often without mechanical modification of the framing member. However, most such devices have required insertion to the T-slot from an open end of the aluminum profile. If it has been desired to mount an object on a framework the connectors to be used to support the object must be placed in the T-slots before assembly of the framework is completed, or, if later modification of the framework is desired to incorporate the object, partial disassembly of the framework has been required.

### SUMMARY OF THE INVENTION

According to the invention there is provided a connector for mounting objects on a frame constructed from extrusion profiles having T-slot channels. The connector includes several folds which allow the connector to be oriented for easy insertion to and removal from the T-slot channel of an aluminum profile extrusions, even after assembly of a frame. When oriented for retention in a T-slot, the connector requires no other retaining fasteners between the connector and the profile extrusion to attach the connector to the extrusion. The connectors provide points of support for external objects to be mounted on a frame. The supported objects in turn lock the accessories in the T-slots by holding the rotational orientation of the connector with respect to the T-slots.

Additional effects, features and advantages will be apparent in the written description that follows.

### BRIEF DESCRIPTION OF THE DRAWINGS

The novel features believed characteristic of the invention are set forth in the appended claims. The invention itself however, as well as a preferred mode of use, further objects and advantages thereof, will best be understood by reference to the following detailed description of an illustrative embodiment when read in conjunction with the accompanying drawings, wherein:

FIG. 1 is a perspective view of mounting connector positioned on a profile extrusion.

FIG. 2 is a perspective view of the mounting connector of the present invention.

FIG. 3 is a side elevation of the mounting connector.

FIG. 4 is a front elevation of the mounting connector;

FIG. 5 is an end view of a profile extrusion illustrating positioning of a mounting connector.

FIG. 6 is a side view of a framework constructed from profile extrusions, the mounting connectors and a supported object.

FIG. 7 is a front view of a framework constructed from profile extrusions, the mounting connectors and a supported object.

### DETAILED DESCRIPTION OF THE INVENTION

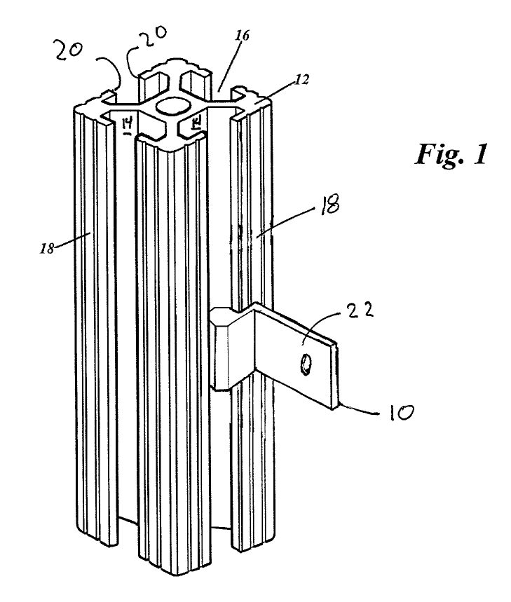

Referring now to FIG. 1, a mounting connector 10 is illustrated with an aluminum alloy extrusion profile 12. Extrusion profile 12 has a rectangular cross-sectional shape and is an elongated member incorporating four T-slot channels 14, which run in parallel to the direction of elongation of profile 12. Each T-slot channel 14 has a slit 16 centered in and opening out on to a major exterior face 18 of the extrusion profile 12. Slits 16 are defined by lips 20 which form part of the major exterior faces 18. Connector 10 is retained in a T-slot 14 upon insertion and rotation to a position which brings mounting plate 22 to a position perpendicular to the major surface 18 adjacent the respective T-slot.

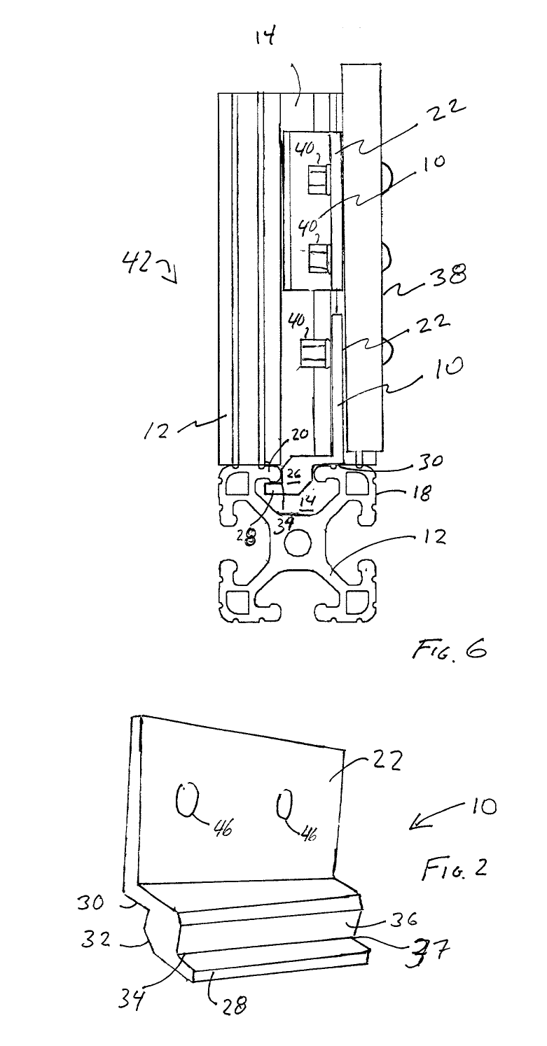

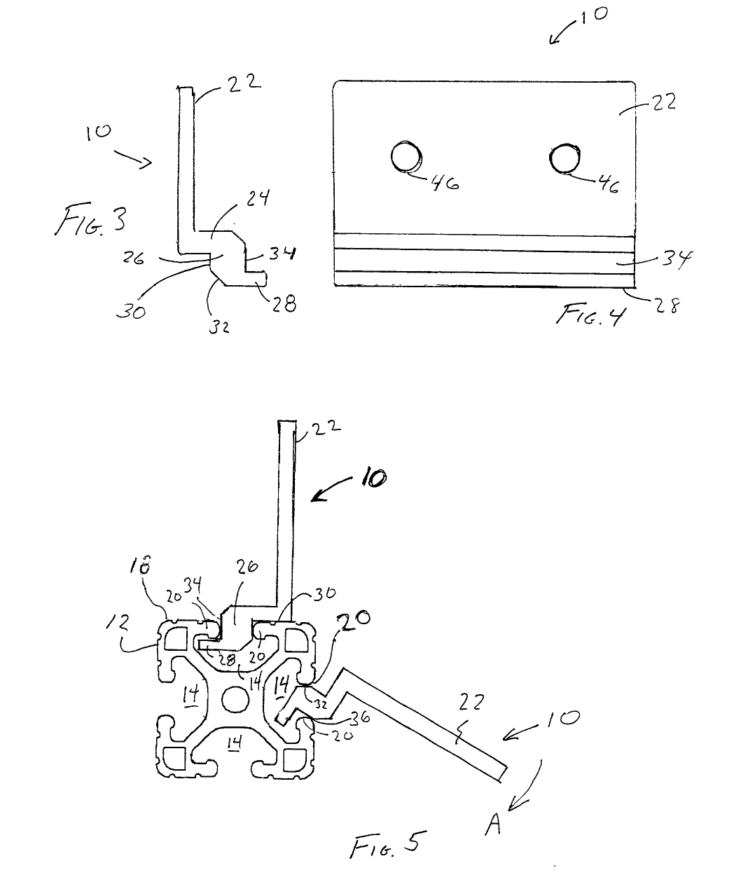

FIGS. 2-4 present connector 10 from several viewpoints. Connector 10 is made from a single piece of material, preferably a single piece of forged aluminum alloy. Connector 10 is shaped as an open W with one extended outside leg corresponding to mounting plate 22. The four segments of connector 10 are mutually perpendicular with respect to adjacent segments. Mounting plate 22 is relatively long compared to the other segments of the connector 10 and in the preferred embodiment is intended to extend orthogonally from a major face 18 of a profile extrusion 12 in use. Mounting plate 22 is upstanding from one end of a seat section 24. Bored into mounting plate 22 are threaded holes 46, which provide a mating point for fasteners used to attache an object to a connector 10. The number of holes 46 depends upon the application although one or two holes are typical.

Projecting downwardly from the end of seat section 24 distal to the mounting plate 22 is a plug section 26. Projecting from the bottom end of plug section 26 in a direction opposite to seat section 24 is a retaining flange 28. The terms “upward” and “downward” here do not refer to the eventual orientations of the connector 10 segments as employed, but only to the relative positions of the elements as depicted in the drawings. Plug section 26 and retaining flange 28 form a key section 37 which, in one rotational orientation of the connector with respect to a T-slot channel 14 may be inserted into or removed from the channel, yet in another orientation be restrained from perpendicular removal from the same channel.

The relative downward oriented surface of seat section 24 and the adjacent orthogonal exterior surface of the plug section 26 form an L-shaped saddle 30. Further down along plug section 26 from saddle 30 is a beveled surface 32, which cuts a 45 degree angle to the adjacent surfaces. Across plug section 26 from the lower arm of saddle 30 is on part of an L-shaped latch surface 36. The interaction of the described segments and surfaces with a T-slot channel 14 is described below with reference to FIG. 5.

Referring now to FIG. 5, two connectors 10 are illustrated, each inserted into a T-slot channel 14 of a profile extrusion 12 and each having a different rotational orientation with respect to the channel. One connector 10 is oriented to bring the mounting plate 22 orthogonal to a major surface 18 of the profile extrusion 12. In this orientation flange 28 is brought up against an interior face of lip 20 forming a portion of the interior of T-slot channel 14. In this position the interaction of flange 28 and lip 20 prevent connector 10 from being pulled directly out of the channel, perpendicular to the direction of elongation of the channel. A connector 10 can be slid in a direction parallel to the channel and out an open of a profile 12 end, if available. Plug section 26 of connector 10 is sufficiently wide to substantially eliminate spacing between the plug section 26 and lips 20. This restricts the freedom of movement of connector 10 perpendicular to, but in the plane of, the T-slot channel 14 in which the connector is positioned.

The second connector 10 is rotated, as is required for directly removing the connector from a T-slot channel 14 or inserting the connector to the channel, without moving the connector through an open end of the profile extrusion 12. Beveled section 32 cuts about a 45 degree angle with respect to adjacent surfaces, an angle selected to result in the insertable end of connector 10 presenting a minimum profile to the slit defined by opposed lips 20. With the connector 10 presenting a minimum profile, the connector can be moved into and out of engagement with a T-slot channel 14. Locking or unlocking engagement is done by rotation of the connector 10, which occurs on a pivot on face 36 of latch section 34, which is on the opposite face of connector 10 from saddle section 30.

The sections and surfaces of connector 10 interact with T-slot channels 14 to retain the connector in a T-slot channel or to allow the connector to be inserted to or withdrawn from a T-slot channel upon rotation of the connector. Connector 10 accordingly is sized to fit a particular size of aluminum profile extrusion. When engaged in a T-slot channel 14, L-shaped saddle section 30 nestles against an outward surface and an adjacent lining surface of a slit formed by one lip 20. The L-shaped latch section 34 nestles against the opposed lip 20, but against an interior surface. Plug section 36 substantially fills the gap between the lips 20.

The preferred use for connectors 10 is in groups, as part of a structure or frame constructed from a two or more profile extrusions 12. Typically, no fasteners are used to hold connectors 10 in a T-slot channel 14. Rather, the connectors are braced in position by interconnection to other connectors 10, where there is at least one connector 10 mounted orthogonally with respect to one or more other connectors 10. In some applications any external brace for a connector 10 may suffice however.

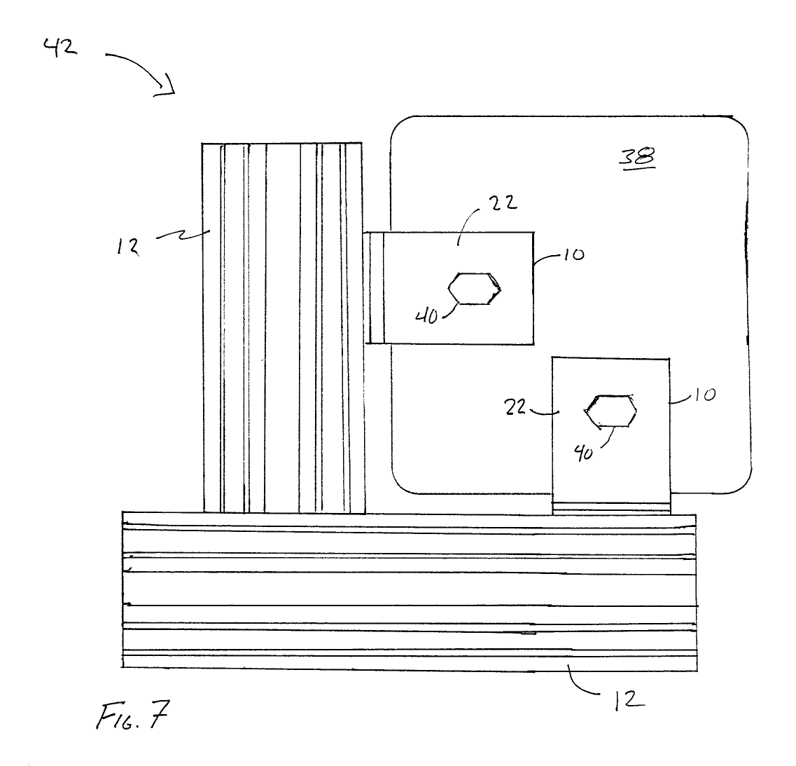

Referring to FIGS. 6-7 an exemplary framework 42 constructed from a board 38, two connectors 10 and two mutually perpendicular profile extrusions 12 is illustrated. Profile extrusions 12 are held in a fixed positional relationship one with respect to the other, typically by employing one or more well-known fasteners or connectors (not shown). FIGS. 6 and 7 differ from one another only in that connectors 10 in the first figure provide two attachment points for a board while those in the second figure have only one. Board 38 is a planer element, supported from two connectors 10, one of which is mounted on each profile extrusion 12. The connectors 10 are positioned in coplaner T-slot channels 14 in a way to position mounting plates 22 in the same plane. Fasteners 40 then attach board 38 to mounting plates 22. Board 22 provides a link between two mutually orthogonal connectors 10 preventing the connectors from being rotated in their respective T-slot channels 14 and from being moved in the direction of elongation of the T-slot channels. In this way the connectors 10 are braced and become part of the overall framework 42 without any additional hardware fastener interacting between a connector and a profile extrusion 12. Other uses of the connectors 10 are conceivable where the connectors are not perpendicular to one another. Any structure which fixes the rotational position of a connector 10 in a T-slot channel 14 may be sufficient in an application. For example, a pair of profiles 12 may be laid in parallel, with connectors positioned across a gap between the profiles. A member connecting the profiles 12 could then support the rotational position of the profiles in their respective T-slot channels 14.

The connector provides mounting hardware for frameworks constructed from aluminum profile extrusions which can be added, or removed, to the framework using a minimum of mounting hardware and can be installed after assembly of the framework.

While the invention is shown in only one of its forms, it is not thus limited but is susceptible to various changes and modifications without departing from the spirit and scope of the invention.

What is claimed is:

1. An interconnection element positionable in a T-slot channel of a profile extrusion for providing a point of support for objects to be mounted on frames constructed from a plurality of profile extrusions, the T-slot channel including an elongated channel within and running the length of the profile extrusion and a slot defined by lips of the profile extrusion providing an opening between the elongated channel and a surface of the profile extrusion, the interconnection element comprising:
a core section for positioning in the slot, the core section having a cross sectional width sufficient to substantially fill the aperture and having a height allowing the core section simultaneously to overlap the slot into the channel and outwardly from the surface, the core section further having a beveled surface allowing the core section to be rotated in the slot;
a retaining flange extending from the core section opposite the beveled surface, the retaining flange being substantially narrower than the aperture to allow its introduction through the aperture into the elongated channel and further being sized to fit between an edge of the aperture and an interior sidewall of the elongated channel to retain the interconnection element from withdrawal from the T-slot channel upon rotation of the interconnection element to an upright position in the T-slot channel;
a ledge extension of the upper portion of the core section extending in a direction opposite and parallel to the retaining flange and displaced from the retaining flange by about the width of the slot; and
a mounting section upstanding from the core section.

2. A mounting plate for use with a profile, said profile being an elongated, rectangular member with a T-channel running the length of the profile, said T-channel being open to an outer surface of the profile along an open slot running the length of the profile, the mounting plate comprising:
a key section sized and shaped for insertion though the open slot into the T-channel upon rotation to present a first aspect to the open slot and further sized and shaped for latching retention within the T-channel upon rotation to present a second aspect to the open slot;
a base section adjacent the key section having a surface for positioning on the outer surface of the structural profile; and
a mounting section depending from the base section away from the positioning surface.

3. The mounting plate of claim 2, further comprising:
the key section having a lead retaining flange which conforms along a surface to an interior portion of the T-channel when the key section is inserted into a T-channel and the mounting plate is rotated to present the second aspect of the key section to the open slot.

4. The mounting plate of claim 3, further comprising:
the key section incorporating a plug section trailing from the lead retaining flange, the plug section being sized to fit snuggly in the slot when the key section is inserted into the T-channel and presents the second aspect to the slot.

5. The mounting plate of claim 4, further comprising:
the plug section having a beveled trailing edge on a side opposite to lead trailing flange allowing the plug section to be pivoted in the open slot to move the key section between second and first aspects relative to the open slot.

6. A frame comprising:
a pair of extrusion profiles having T-slot channels;
the pair of extrusion profiles being positioned with respect to one another;
a pair of connectors, one of which connectors depends from a T-slot channel in each of the extrusion profiles, and which is retained in the T-slot channel by a particular rotational orientation; and
a member attached to each of the pair of connectors which holds the connectors in the particular rotational orientation.

7. The frame of claim 6, further comprising:
each extrusion being an elongated, rectangular member with the T-slot channel running the length of the extrusion profile, the T-channel being open to an outer surface of the extrusion profile along an open slot running the length of the profile.

8. The frame of claim 7, further comprising:
each connector having;
a key section sized and shaped for insertion though the open slot into the T-slot channel upon rotation to present a first aspect to the open slot and further sized and shaped for latching retention within the T-slot channel upon rotation to present a second aspect to the open slot;
a base section adjacent the key section having a surface for positioning on the outer surface of the structural profile; and
a mounting section depending from the base section away from the positioning surface.

9. The frame of claim 8, further comprising:
the key section having a lead retaining flange which conforms along a surface to an interior portion of the T-slot channel when the key section is inserted into a T-slot channel and the connector is rotated to present the second aspect of the key section to the open slot.

10. The mounting plate of claim 9, further comprising:
the key section incorporating a plug section trailing from the lead retaining flange, the plug section being sized to fit snuggly side to side in the open slot when the key section is inserted into the T-slot channel and presents the second aspect to the open slot.

11. The mounting plate of claim 10, further comprising:
the plug section having a beveled trailing edge on a side opposite to lead trailing flange allowing the plug section to be pivoted in the open slot to move the key section between second and first aspects relative to the open slot.
